(19) United States
(12) Patent Application Publication
(10) Pub. No.: US 2019/0279165 A1
(43) Pub. Date: Sep. 12, 2019

(54) MANAGEMENT SYSTEM, MANAGEMENT METHOD, AND NON-TRANSITORY COMPUTER READABLE STORAGE MEDIUM STORING PROGRAM

(71) Applicant: Toyota Jidosha Kabushiki Kaisha, Toyota-shi Aichi-ken (JP)

(72) Inventors: Shin Sakurada, Toyota-shi Aichi-ken (JP); Tomoya Suzuki, Toyota-shi Aichi-ken (JP); Hideo Hasegawa, Nagoya-shi Aichi-ken (JP); Takao Hishikawa, Nagoya-shi Aichi-ken (JP)

(73) Assignee: Toyota Jidosha Kabushiki Kaisha, Toyota-shi Aichi-ken (JP)

(21) Appl. No.: 16/285,366

(22) Filed: Feb. 26, 2019

(30) Foreign Application Priority Data
Mar. 12, 2018 (JP) 2018-044232

(51) Int. Cl. G06Q 10/00; G06Q 50/30

(52) U.S. Cl. CPC G06Q 10/20; G06Q 50/30

(57) ABSTRACT

A management system includes a processor configured to: receive information regarding whether or not cooperation for a maintenance work of a shared car is agreed; and execute any processing selected from a plurality of kinds of processing based on the information received, the processing changing a shared car use condition for a user who is not a lender of the shared car and who has cooperated for the maintenance work such that the shared car use condition becomes better than a shared car use condition for a user who is not the lender of the shared car and who does not cooperate for the maintenance work.

### CROSS-REFERENCE TO RELATED APPLICATIONS

This application claims priority to Japanese Patent Application No. 2018-044232 filed on Mar. 12, 2018, which is incorporated herein by reference in its entirety including the specification, drawings and abstract.

### BACKGROUND

### 1. Technical Field

The disclosure relates to a management system, a management method, and a non-transitory computer readable storage medium that stores a program.

### 2. Description of Related Art

Due to development of information and communication technologies, changes in lifestyles, or for financial reasons, the period of private ownership is changing to the period of community sharing. For car sharing, members are able to mutually share a shared car, check usage status and make reservations of the shared car through the internet and so on. With such car sharing, users are able to cut costs for purchasing, maintaining, and parking vehicles, and so on, compared to owning a vehicle. Due to this situation, the needs for car sharing are on the rise, and there is not only a service form where a car sharing business operator offers a car sharing service, but also a service form where a shared car is borrowed and lent between individuals. The car sharing between individuals is a service where users who are registered as members borrow or lend privately-owned vehicles, and is advantageous because a user who borrows a vehicle is able to use it at a relatively low price, and a user who lends a vehicle is able to receive the value by lending out the vehicle when he or she does not use it. Many components of a vehicle that is used for car sharing are expendable with limited service lives. Therefore, it is desirable that maintenance of a vehicle such as component replacement is carried out at appropriate timing. In consideration of such situation, Japanese Unexamined Patent Application Publication No. 2002-370630 (JP 2002-370630 A) proposes a preventive maintenance service system. This system determines a deterioration state of a component to be inspected based on a service life of the component to be inspected that is used in a vehicle, and information about a condition of the vehicle component provided by a component condition sensor mounted on the vehicle component, or based on a traveling environment where the vehicle is used, an environment of a road where the vehicle travels, and a travel distance in accordance with the service life of the vehicle component. Then, the system gives a warning of component replacement when the deterioration state of the components to be inspected reaches a predetermined standard.

### SUMMARY

In the car sharing service offered by a car sharing business operator, a shared car is maintained as necessary. Meanwhile, in the car sharing service where a shared car is borrowed and lent between individuals, the shared car may not be maintained sufficiently. Use of a poorly-maintained shared car is not desirable in terms of safety, and could deteriorate reliability of the car sharing service.

The disclosure provides a management system, a management method, and a non-transitory computer readable storage medium that stores a program configured to promote maintenance of a shared car.

A first aspect of the present disclosure relates to a management system including a processor configured to: receive information regarding whether or not cooperation for a maintenance work of a shared car is agreed; and execute any processing selected from a plurality of kinds of processing based on the information received, the processing changing a shared car use condition for a user who is not a lender of the shared car and who has cooperated for the maintenance work such that the shared car use condition becomes better than a shared car use condition for a user who is not the lender of the shared car and who does not cooperate for the maintenance work.

A second aspect of the present disclosure relates to a management system including a processor configured to: transmit maintenance guide information about a shared car to a communication terminal of a lender of the shared car; and execute any processing selected from a plurality of kinds of processing that changes a shared car lending condition for a lender who does not do maintenance of the shared car despite reception of the guide information such that the shared car lending condition becomes worse than a shared car lending condition for a lender who does maintenance of the shared car in response to the guide information.

With the management system according to the above aspects, maintenance of a shared car is promoted.

A third aspect of the present disclosure relates to a management method including: by using a computer system, receiving information regarding whether or not cooperation for a maintenance work of a shared car is agreed; and by using the computer system, executing any processing selected from a plurality of kinds of processing based on the information received, the processing changing a shared car use condition for a user who is not a lender of the shared car and who has cooperated for the maintenance work such that the shared car use condition becomes better than a shared car use condition for a user who is not the lender of the shared car and does not cooperate for the maintenance work.

A fourth aspect of the present disclosure relates to a management method including: by using a computer system, transmitting maintenance guide information about a shared car to a communication terminal of a lender of the shared car; and by using the computer system, executing any processing selected from a plurality of kinds of processing that changes a shared car lending condition for a lender who does not do maintenance of the shared car regardless of the guide information such that the shared car lending condition becomes worse than a shared car lending condition for a lender who does maintenance of the shared car in response to the guide information.

With the management method according to the above aspects, maintenance of a shared car is promoted.

Furthermore, with a non-transitory computer readable storage medium that stores a program that makes a computer system execute the management method of the above aspects, maintenance of a shared car is promoted.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a view describing a hardware configuration of a management system according to an embodiment of the disclosure.

### DETAILED DESCRIPTION OF EMBODIMENTS

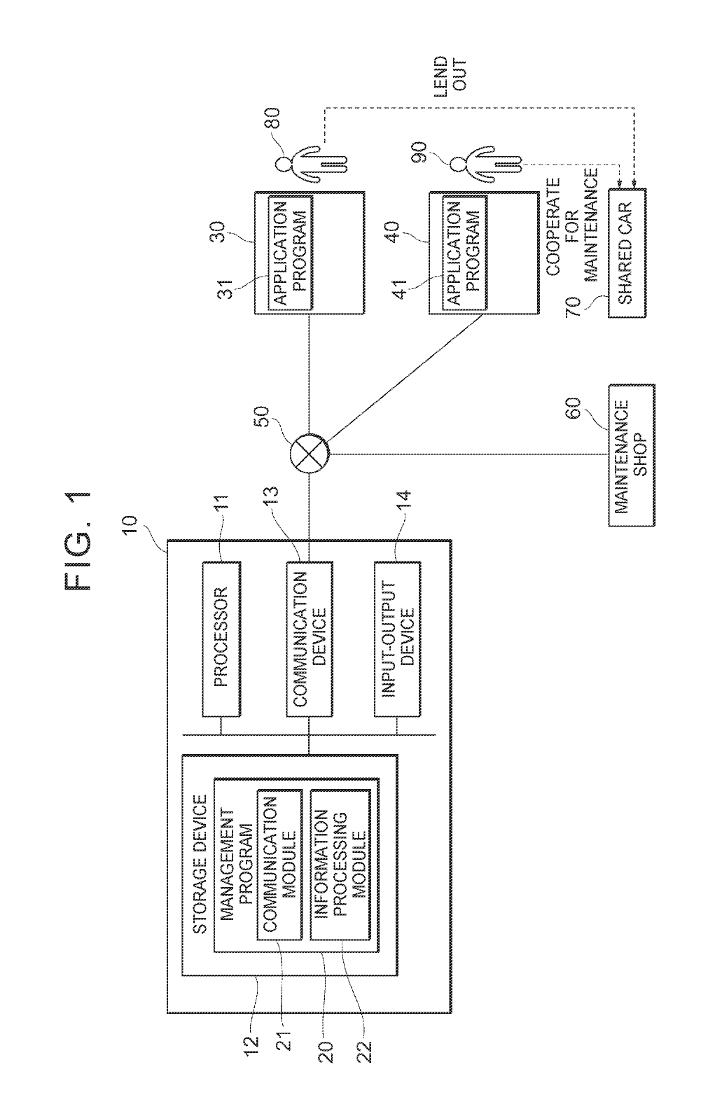

An embodiment of the disclosure is described below with reference to the drawings. Constituents denoted by the same reference numerals mean they are the same, and duplicated description of such constituents is omitted. FIG. 1 is a view describing a hardware configuration of a management system 10 according to the embodiment of the disclosure. The management system 10 is a computer system (for example, a Web server) that does management of a shared car 70 (for example, management of a maintenance condition and reservations of the shared car 70). The term “shared car” means a vehicle that is provided for shared use (for example, joint use by members). The term “vehicle” includes vehicles stipulated in laws about road traffic in the country in which the present disclosure is carried out (for example, a motor vehicle, a motorized bicycle, and a light load vehicle according to Japanese Road Traffic Act).

The management system 10 includes a processor 11, a storage device 12, a communication device 13, and an input-output device 14 as its hardware resources. The storage device 12 stores a management program 20 that executes a management method for managing a maintenance state of the shared car 70. The management program 20 includes a communication module 21 and an information processing module 22. These modules are modularized subprograms, and the communication module 21 collaborates with the hardware resources of the management system 10 and realizes a function of communication. Similarly, the information processing module 22 collaborates with the hardware resources of the management system 10 and realizes a function as information processing. Functions of the communication module 21 and the information processing module 22 are detailed later. The storage device 12 is a storage resource provided by a computer readable storage medium (for example, a volatile memory, a nonvolatile semiconductor memory, and disk media). The communication device 13 is, for example, a communication device corresponding to a telecommunication standard such as Long-Term Evolution. The input-output device 14 includes an input device (for example, a keyboard, a mouse, or a touch panel) by which information is input to the management system 10, and an output device (for example, a display or a printer) by which information is output from the management system 10.

In a communication terminal 30 owned by a user 80 who is a member of car sharing, an application program (for example, a Web client) 31 is implemented. The application program 31 executes processing such as input, change, and cancellation of a reservation for a shared car. In a communication terminal 40 owned by a user 90 who is a member of car sharing, an application program 41 having similar functions as those of the application program 31 is implemented. The communication terminals 30, 40 may be mobile communication terminals, or personal computers having a communication function. The mobile communication terminals include, for example, a multi-function mobile phone that is called a smartphone, or a tablet terminal.

A maintenance shop 60 is a shop provided with facilities used to carry out maintenance and inspection (for example, legal inspection) of the shared car 70.

The management system 10, the communication terminals 30, 40, and the maintenance shop 60 are connected with each other by a communication network 50. The communication network 50 is a communication network in which, for example, a wired network (for example, a local-area network (LAN), a wide-area network (WAN), or a value-added network (VAN)) and a wireless network (for example, a mobile communication network, a satellite communication network, Bluetooth (registered trademark), Wireless Fidelity (Wi-Fi), and High Speed Downlink Packet Access (HSDPA)) are mixed.

The shared car 70 is a vehicle that the user 80 lends out for the car sharing service as a lender.

The maintenance shop 60 transits maintenance information of the shared car 70 to the management system 10 through the communication network 50. The maintenance information includes maintenance history information about the shared car 70 (for example, information regarding whether or not a component that is determined that replacement is required has been replaced, timing for replacement of the component, a travel distance when the component is replaced), and recommended maintenance information (for example, information regarding recommended time for next maintenance or inspection, or recommended time for component replacement).

Once the management system 10 receives maintenance history information and recommended maintenance information about the shared car 70, the management system 10 executes processing of estimating recommended time for the next maintenance or inspection of the shared car 70 based on the information received. As the recommended time for the next maintenance or inspection of the shared car 70 approaches (for example, a few weeks before the recommended time), the communication module 21 transmits information that invites users to cooperate for a maintenance work of the shared car 70 (for example, cooperation to move the shared car 70 to the maintenance shop 60) through the communication network 50.

The user 90 is connected with the management system 10 from the communication terminal 40 through the communication network 50, and is able to do various procedures regarding reservations of the shared car 70 (for example, receiving, changing, and cancelling reservations). For example, these procedures are done as a reservation interface on a webpage is shown on a display of the communication terminal 40 through transmission and receipt of requests and responses conforming to Hypertext Transfer Protocol between the communication terminal 40 and the management system 10. The reservation interface shows, for example, information that invites users who cooperate for a maintenance work of the shared car 70.

During the reservation procedures of the shared car 70, the user 90 is able to notify the management system 10 from the communication terminal 40 through the communication network 50 that he or she will cooperate for the maintenance work of the shared car 70. Thus, the communication module 21 receives information from the communication terminal 40 regarding whether or not the cooperation on the maintenance work of the shared car 70 is agreed. Once the user 90 who went through the reservation procedures arrives at a location of the shared car 70 at starting time and date, the user 90, for example, allows a card reader of the shared car 70 to read authentication information recorded in an IC card obtained at the time of member registration for the car sharing, and then the user 90 is authenticated. Then, doors of the shared car 70 are unlocked, and the user 90 takes out a key from a key box, so that the user 90 is able to use the shared car 70. Then, once the user 90 gets in the shared car 70, the user 90 drives the shared car 70 by himself or herself, moves the shared car 70 to the maintenance shop 60, and goes through check-in procedures. Once the maintenance shop 60 confirms that the shared car 70 has been checked-in, the maintenance shop 60 notifies the management system 10 through the communication network 50 that the shared car 70 has been checked in.

Once the management system 10 receives the notification from the maintenance shop 60 that it is confirmed that the shared car 70 has been checked in, the information processing module 22 executes any processing selected from a plurality of kinds of processing by which use conditions of the shared car 70 for the user 90 who is not the lender and cooperated for the maintenance work of the shared car 70 become better than use conditions of the shared car 70 for users who are not the lender and did not cooperate for the maintenance work. It may be the information processing module 22 which selects any one of the plurality kinds of processing, or it may be the user 90 having cooperated for the maintenance work who selects the processing. For example, the information processing module 22 may follow predetermined rules in selecting any one of the plurality kinds of processing. Alternatively, for example, the user 90 may select any one of the kinds of processing in the reservation procedures of the shared car 70 or in the procedures for checking in the shared car 70 at the maintenance shop 60. The kinds of processing may include, for example, any one of or a combination of (i) processing of discounting a charge when the user 90 who cooperated for the maintenance work uses the shared car 70, (ii) processing of giving points equivalent to the discount of the charge, (iii) processing of raising a rating (a quantified evaluation value of the user 90 in the car sharing service) of the user 90 who cooperated for the maintenance work, and (iv) processing of raising a rating (a quantified evaluation value of the shared car in the car sharing service) of a shared car lent out by the user 90 who cooperated for the maintenance work if such a shared car exists.

Table 1 shows an example of comparison between the use conditions of the shared car 70 for the user 90 who is not the lender of the shared car 70 and cooperated for the maintenance work, and the use conditions of the shared car 70 for a user who is not the lender of the shared car 70 and does not cooperate for the maintenance work. Better conditions mean conditions that are economically more advantageous for a user who uses a shared car. A use condition of the shared car 70 for a user 90 may be also referred to as “a shared car use condition for a user”.

TABLE 1

| | |
|---|---|
| Shared car use condition for a user who | Shared car use condition for a user who |
| cooperated for a maintenance work | does not cooperate for a maintenance work |
| A charge imposed for use of the shared car | A charge imposed for use of the shared car |
| is discounted. | is not discounted. |
| Points equivalent to the discount of the | Points equivalent to the discount of the |
| charge for use of the shared car are given. | charge for use of the shared car are not |
| | given. |
| A rating of a user who cooperated for a | A rating of a user who does not cooperate |
| maintenance work is raised. | for a maintenance work remains the same. |
| A rating of a shared car lent by a user who | A rating of a shared car lent by a user who |
| cooperated for a maintenance work is | does not cooperate for a maintenance work |
| raised. | remains the same. |

In the foregoing description, an example is described where the user 90 notifies the management system 10, from the communication terminal 40 through the communication network 50, that the user 90 agrees to cooperate for the maintenance work of the shared car 70 in the reservation procedures of the shared car 70. However, it is not necessarily required for the user 90 to carry out the reservation procedures of the shared car 70 in order to make such a notification. Also, the information that invites users to cooperate for the maintenance work of the shared car 70 may be shown on a different interface from the reservation interface of the shared car 70 (for example, an interface where the shared car 70 is introduced).

The shared car 70 may be mounted with a sensor that detects consumption or abnormality of onboard components, generates maintenance information that recommends inspection or replacement of a component of the shared car 70 based on a signal from the sensor, and transmits the maintenance information to the management system 10 through a radio line. For example, when tire air pressure of the shared car 70 is temporarily reduced and then returns to specified pressure, it is assumed that a tire had a puncture and then the puncture was repaired later. Therefore, the shared car 70 may transmit maintenance information that recommends tire replacement to the management system 10 through a wireless network. Thus, the management system 10 is able to estimate recommended time for next maintenance or inspection of the shared car 70 by using either one or both of the maintenance information transmitted to the management system 10 from the maintenance shop 60 and the maintenance information transmitted to the management system 10 from the shared car 70.

As the recommended time for the next maintenance or inspection of the shared car 70 approaches (for example, a few weeks before the recommended time), the communication module 21 may transmit maintenance guide information (for example, information that recommends inspection or maintenance at the maintenance shop 60) about the shared car 70 to the communication terminal 30 of the user 80 who is the lender of the shared car 70. When the user 80 responds to the guide information, the user 80 is able to get in and drive the shared car 70 by herself or himself, move the shared car 70 to the maintenance shop 60, and go through the check-in procedures. Once the maintenance shop 60 confirms that the shared car 70 has been checked in, the maintenance shop 60 notifies the management system 10 through the communication network 50 that the shared car 70 has been checked in. Meanwhile, when the user 80 does not respond to the guide information, the maintenance shop 60 notifies the management system 10 through the communication network 50 that checking-in of the shared car 70 cannot be confirmed by the recommended time for maintenance or inspection.

Once the management system 10 receives the notification from the maintenance shop 60 that it cannot be confirmed that the shared car 70 has been checked in, the information processing module 22 executes any processing that is selected from a plurality of kinds of processing. By this processing, lending conditions of the shared car 70 for the user 80 who is the lender and does not carry out maintenance of the shared car 70 regardless of the guide information becomes worse than lending conditions of the shared car 70 for the user 80 who is the lender and does maintenance of the shared car 70 in response to the guide information. It may be the information processing module 22 which selects any one of the plurality of kinds of processing, or it may be the user 80 not doing maintenance of the shared car 70 who select the processing. For example, the information processing module 22 may follow predetermined rules in selecting any one of the plurality of kinds of the processing. Alternatively, for example, the user 80 may connect with the management system 10 from the communication terminal 30 in response to the guide information transmitted by the management system 10 and select any one of the plurality of kinds of processing. The kinds of the processing may include, for example, any one of or a combination of (i) processing of lowering a rating (a quantified evaluation value of the user 80 in the car sharing service) of the user 80 who does not do maintenance of the shared car 70, (ii) processing of lowering a rating of the shared car 70 that is not maintained, and (iii) processing of prohibiting lending of the shared car 70 that is not maintained.

Table 2 shows an example of comparison between the lending conditions of the shared car 70 for the user 80 who is the lender and does not do maintenance of the shared car 70 regardless of the guide information, and lending conditions of the shared car 70 for the user 80 who is the lender and does maintenance of the shared car 70 in response to the guide information. Worse lending conditions mean conditions that are economically less advantageous for the lender of the shared car 70. A lending condition of the shared car 70 for a user 80 may be referred to as “a shared car lending condition for a lender”.

TABLE 2

| | |
|---|---|
| Shared car lending conditions for a lender | Shared car lending conditions for a lender |
| who does not do maintenance of the car | who does maintenance of the car |
| A rating of a lender who does not do | A rating of a lender who does maintenance |
| maintenance of a car is lowered. | of a car remains the same. |
| A rating of a shared car that is not | A rating of a shared car that is maintained |
| maintained is lowered. | remains the same. |
| Lending of a shared car that is not | Lending of a shared car that is maintained is |
| maintained is prohibited. | permitted. |

According to the embodiment of the disclosure, information that invites users who cooperate for a maintenance work of the shared car 70 is transmitted through the communication network 50, and use conditions of the shared car 70 for the user 90 who cooperated for the maintenance work become better. It is thus possible to promote vehicle maintenance in collaboration with the user 90 other than the user 80 who is the lender of the shared car 70, thereby improving safety of the shared car 70 and the car sharing service.

Further, according to the embodiment of the disclosure, maintenance guide information about the shared car 70 is transmitted to the communication terminal 30 owned by the user 80 who is the lender of the shared car 70, and lending conditions of the shared car 70 for the user 80 who does not do maintenance of the shared car 70 are made worse. Thus, the user 80 is encouraged to voluntarily do maintenance of the shared car 70, thereby improving safety of the shared car 70 and the car sharing service.

The embodiment described above is intended to facilitate understanding of the disclosure, and does not limit interpretation of the disclosure. The disclosure may be changed or improved without departing from the gist of the disclosure, and the disclosure includes its equivalents. For example, functions similar to those of the modules of the management program 20 (the communication module 21 and the information processing module 22) may be realized by using a dedicated hardware resource (for example, application specific integrated circuit (ASIC), or a field programmable gate array (FPGA)) or a firmware. Also, the functions of the management system 10 are not necessarily realized by a single computer system, and may be realized by a plurality of computer systems connected with the communication network 50.

What is claimed is:

1. A management system comprising a processor configured to:
receive information regarding whether or not cooperation for a maintenance work of a shared car is agreed; and
execute any processing selected from a plurality of kinds of processing based on the information received, the processing changing a shared car use condition for a user who is not a lender of the shared car and who has cooperated for the maintenance work such that the shared car use condition becomes better than a shared car use condition for a user who is not the lender of the shared car and who does not cooperate for the maintenance work.

2. The management system according to claim 1, wherein the processor is configured to execute any processing selected, from the plurality of kinds of processing, by the user who is not the lender of the shared car and who has cooperated for the maintenance work.

3. The management system according to claim 1, wherein the plurality of kinds of processing include at least one of the following processing:
i) processing of discounting a charge when the user who has cooperated for the maintenance work uses a shared car;
ii) processing of giving points equivalent to a discount of the charge to the user who has cooperated for the maintenance work;
iii) processing of raising a rating of the user who has cooperated for the maintenance work; and
iv) processing of raising a rating of a shared car lent out by the user who has cooperated for the maintenance work.

4. A management system comprising a processor configured to:
transmit maintenance guide information about a shared car to a communication terminal of a lender of the shared car; and
execute any processing selected from a plurality of kinds of processing that changes a shared car lending condition for a lender who does not do maintenance of the shared car despite reception of the guide information such that the shared car lending condition becomes worse than a shared car lending condition for a lender who does maintenance of the shared car in response to the guide information.

5. The management system according to claim 4, wherein the processor is configured to execute any processing selected, from the plurality of kinds of processing, by the lender who does not do maintenance of the shared car.

6. The management system according to claim 4, wherein the plurality of kinds of processing include at least one of the following processing:
i) processing of lowering a rating of the lender who does not do maintenance of the shared car;
ii) processing of lowering a rating of the shared car that is not maintained; and
iii) processing of prohibiting lending of the shared car that is not maintained.

7. A management method comprising:
by using a computer system, receiving information regarding whether or not cooperation for a maintenance work of a shared car is agreed; and
by using the computer system, executing any processing selected from a plurality of kinds of processing based on the information received, the processing changing a shared car use condition for a user who is not a lender of the shared car and who has cooperated for the maintenance work such that the shared car use condition becomes better than a shared car use condition for a user who is not the lender of the shared car and does not cooperate for the maintenance work.

8. A management method comprising:
by using a computer system, transmitting maintenance guide information about a shared car to a communication terminal of a lender of the shared car; and
by using the computer system, executing any processing selected from a plurality of kinds of processing that changes a shared car lending condition for a lender who does not do maintenance of the shared car regardless of the guide information such that the shared car lending condition becomes worse than a shared car lending condition for a lender who does maintenance of the shared car in response to the guide information.

9. A non-transitory computer readable storage medium that stores a program that makes a computer system execute the management method of claim 7.

10. A non-transitory computer readable storage medium that stores a program that makes a computer system execute the management method of claim 8.
